(19) United States
(12) Patent Application Publication
(10) Pub. No.: US 2026/0340663 A1
(43) Pub. Date: Oct. 29, 2026

(54) STORE DETERMINATION DEVICE

(71) Applicant: NTT DOCOMO, INC., Tokyo (JP)

(72) Inventors: Akinari SAKAI, Chiyoda-ku (JP); Tetsuya YAMAGUCHI, Chiyoda-ku (JP); Yusuke NAKAMURA, Chiyoda-ku (JP)

(73) Assignee: NTT DOCOMO, INC., Tokyo (JP)

(21) Appl. No.: 18/995,536

(22) PCT Filed: Jun. 23, 2023
(86) PCT No.: PCT/JP2023/023380

§ 371 Date: Jan. 16, 2025

(30) Foreign Application Priority Data
Sep. 1, 2022 (JP) 2022-139014

(51) Int. Cl. G06Q 30/0201

(52) U.S. Cl. CPC G06Q 30/0201

(57) ABSTRACT

An object is to determine a store that a user is visiting. A store determination device 1, includes: a computation unit 12 computing a degree of similarity between user adjacency information relevant to adjacency between each user and other users and store adjacency information relevant to adjacency between each store and other users assumed as a user who is visiting the store; and a determination unit 13 determining the store that the user is visiting, on the basis of the degree of similarity computed by the computation unit 12. Adjacency between users may be adjacency between mobile terminals 2 carried by each user.

### TECHNICAL FIELD

One aspect of the present disclosure relates to a store determination device determining a store that a user is visiting.

### BACKGROUND ART

In Patent Literature 1 described below, an application server control module is disclosed in which it is possible to disclose a dynamic cluster relevant to a cluster based on persons by clustering an approach or an encounter between persons adjacent to a reference person (Paragraph 0143).

### CITATION LIST

### Patent Literature

Patent Literature 1: International Publication WO 2019/049356

### SUMMARY OF INVENTION

### Technical Problem

The application server control module discloses the dynamic cluster relevant to the cluster based on the persons, but for example, is not capable of determining a store that the reference person (a user) is visiting. Therefore, it is desirable to determine the store that the user is visiting.

### Solution to Problem

A store determination device according to one aspect of the present disclosure, includes: a computation unit computing a degree of similarity between user adjacency information relevant to adjacency between each user and other users and store adjacency information relevant to adjacency between each store and other users assumed as a user who is visiting the store; and a determination unit determining the store that the user is visiting, on the basis of the degree of similarity computed by the computation unit.

In such an aspect, the degree of similarity between the user adjacency information for each user and the store adjacency information for each store is computed, and the store that the user is visiting is determined on the basis of the computed degree of similarity. That is, it is possible to determine the store that the user is visiting.

### Advantageous Effects of Invention

According to one aspect of the present disclosure, it is possible to determine the store that the user is visiting.

### BRIEF DESCRIPTION OF DRAWINGS

FIG. 1 A diagram illustrating an example of a system configuration of a store determination system including a store determination device according to an embodiment.

FIG. 2 A diagram illustrating a table example of contact information.

FIG. 3 A diagram illustrating an example of a functional configuration of the store determination device according to the embodiment.

FIG. 4 A diagram illustrating a table example of connection information.

FIG. 5 A diagram illustrating a table example of ground truth information.

FIG. 6 A diagram illustrating a table example of user adjacency information.

FIG. 7 A diagram illustrating a table example of store adjacency information.

FIG. 8 A diagram illustrating a table example of degree of similarity information.

FIG. 9 A diagram illustrating an example of a degree of similarity for each user and for each store.

FIG. 10 A diagram illustrating an example of a degree of similarity for each user and for each store.

FIG. 11 A diagram illustrating an example of a degree of reliability weighted for each user and for each store.

FIG. 12 A diagram illustrating a table example of visit flag information.

FIG. 13 A diagram illustrating a table example of visit determination information.

FIG. 14 A diagram illustrating a table example of visit date and time information.

FIG. 15 A flowchart illustrating an example of processing executed by the store determination device according to the embodiment.

FIG. 16 A flowchart illustrating another example of the processing executed by the store determination device according to the embodiment.

FIG. 17 A diagram illustrating a problem of store determination according to the related art.

FIG. 18 A diagram illustrating an example of a hardware configuration of a computer used in the store determination device according to the embodiment.

### DESCRIPTION OF EMBODIMENTS

Hereinafter, an embodiment of the present disclosure will be described in detail with reference to the drawings. Note that in the description of the drawings, the same reference numerals will be applied to the same elements, and the repeated description will be omitted. In addition, the embodiment of the present disclosure in the following description is a specific example of the present invention, and the present invention is not limited to the embodiment unless otherwise specified to limit the present invention.

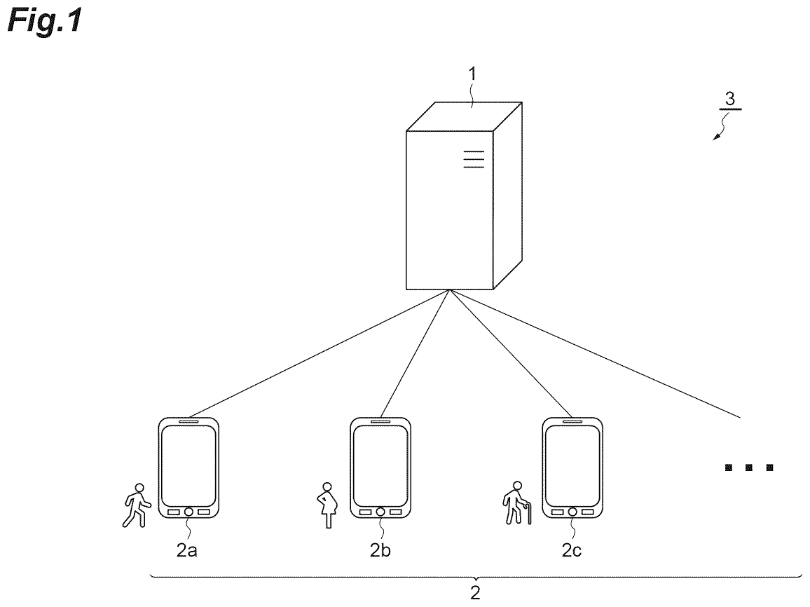

FIG. 1 is a diagram illustrating an example of a system configuration of a store determination system 3 including a store determination device 1 according to an embodiment. As illustrated in FIG. 1, the store determination system 3 is configured by including a store determination device 1 and one or more mobile terminals 2 (a mobile terminal 2a, a mobile terminal 2b, a mobile terminal 2c, . . . will be suitably referred to as a mobile terminal 2 in an all-inclusive term). The store determination device 1 and each of the mobile terminals 2 are connected to each other by a network such as a mobile communication network such that communication is available, and are capable of transmitting and receiving information to and from each other.

The store determination device 1 is a computer device (a server) determining a store that a user is visiting. The user is a person using a function or a service provided by the store determination device 1. Each user carries the mobile terminal 2. A user for whom the store determination device 1 determines a store that the user is visiting will be suitably referred to as a target user. A user whose visit with respect to a store is not known is assumed as the target user. The store, for example, is a building for selling products, a building or an area for providing services, or the like. The details of the store determination device 1 will be described below.

The mobile terminal 2 is a mobile communication terminal performing mobile communication or a computer device such as a laptop computer. In this embodiment, a smart phone is assumed as the mobile terminal 2, but the mobile terminal is not limited thereto. The mobile terminal 2 is carried by each user as described above.

The mobile terminal 2 is capable of performing near-field wireless communication by Bluetooth (Registered Trademark) low energy (BLE), which is a part of Bluetooth (Registered Trademark), or the like. In a case where the mobile terminals 2 fall within a certain distance range, the mobile terminals 2 automatically exchange identification information of the own terminal with each other by the near-field wireless communication without the operation of the user or the like. Falling within the certain distance range is also referred to as being in contact with each other or adjacent to each other. It is indicated that each of the mobile terminals 2 is in contact with the opponent mobile terminal 2 or the user of the mobile terminal 2 is in contact with the user of the opponent mobile terminal 2 by exchanging the identification information of the own terminal. In this embodiment, a user ID for identifying the user carrying the mobile terminal 2 is used as the identification information of the own terminal (the mobile terminal 2), but the identification information is not limited thereto.

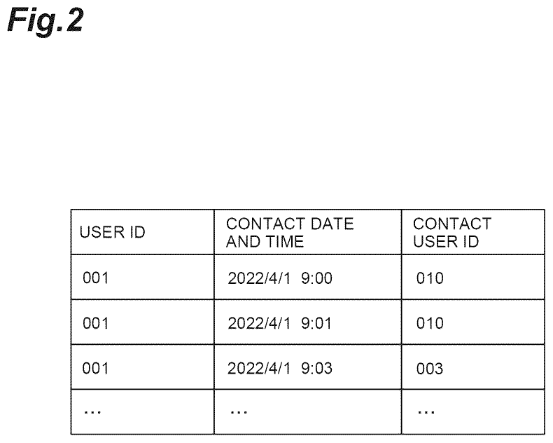

The mobile terminal 2 (assumed as the mobile terminal 2a) generates contact information relevant to contact between users, on the basis of a user ID (a contact user ID) of the user carrying the mobile terminal 2b, which is received from the mobile terminal 2b when the mobile terminal 2 is in contact with another mobile terminal 2 (assumed as the mobile terminal 2b). FIG. 2 is a diagram illustrating a table example of the contact information. In the contact information illustrated in FIG. 2, a user ID of the user carrying the mobile terminal 2 (for example, the mobile terminal 2a) that is the own terminal, a contact date and time that is a date and time when the mobile terminal 2 is in contact with another mobile terminal 2 (for example, the mobile terminal 2b or the like), and a contact user ID that is a user ID of a user carrying another mobile terminal 2 are associated with each other. The mobile terminal 2 transmits the contact information to the store determination device 1 periodically (for example, every minute). The contact information may be referred to as a BLE log.

In addition, the mobile terminal 2 may have functions, sensors, or the like provided in a general smart phone, such as an electrical wave positioning function, a positioning function of a global positioning system (GPS), or a payment function, and may transmit information or the like acquired by such functions or sensors to the store determination device 1.

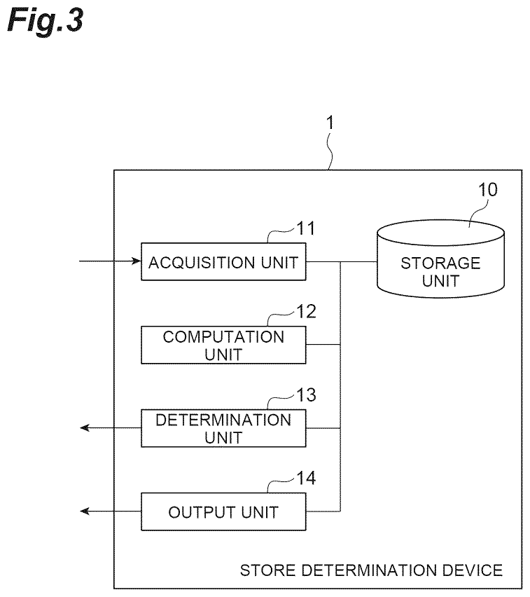

FIG. 3 is a diagram illustrating an example of a functional configuration of the store determination device 1 according to the embodiment. As illustrated in FIG. 3, the store determination device 1 is configured by including a storage unit 10 (a storage unit), an acquisition unit 11, a computation unit 12 (a computation unit), a determination unit 13 (a determination unit), and an output unit 14.

Each function block of the store determination device 1 is assumed to function in the store determination device 1, but is not limited thereto. For example, a part of the function blocks of the store determination device 1 may function in a computer device that is different from the store determination device 1 and is connected to the store determination device 1 via a network while suitably transmitting and receiving information with respect to the store determination device 1. In addition, a part of the function blocks of the store determination device 1 may not be provided, a plurality of function blocks may be integrated into one function block, or one function block may be decomposed into a plurality of function blocks.

Hereinafter, each function of the store determination device 1 illustrated in FIG. 3 will be described.

The storage unit 10 stores any information used for computation or the like in the store determination device 1, a result of the computation in the store determination device 1, and the like. The information stored by the storage unit 10 may be suitably referred to by each function of the store determination device 1.

The information stored by the storage unit 10 may be information that is acquired by the acquisition unit 11 and stored, may be information that is generated by the acquisition unit 11 or the computation unit 12 and stored, may be information that is input by an administrator or the like of the store determination device 1 and stored, or may be information that is stored in advance.

The storage unit 10 may store the contact information (described above).

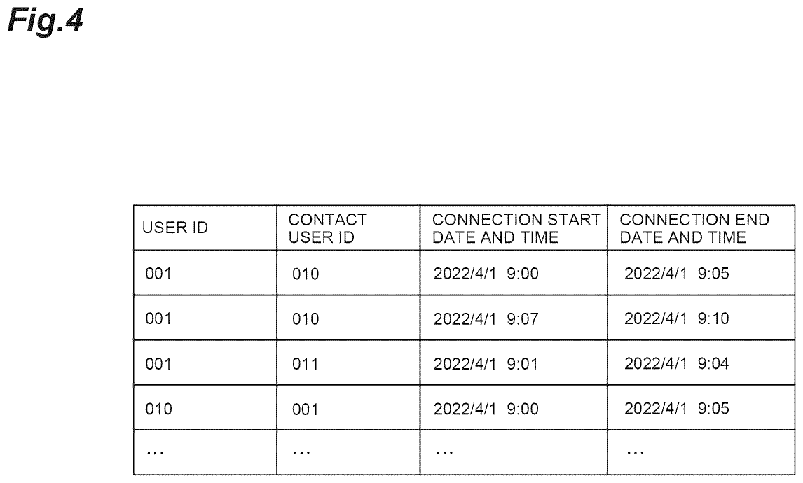

The storage unit 10 may store connection information relevant to connection between users, which is generated on the basis of the contact information. The connection indicates continuous contact. FIG. 4 is a diagram illustrating a table example of the connection information. In the connection information illustrated in FIG. 4, the user ID of the user carrying the mobile terminal 2, the contact user ID that is the user ID of the user carrying the another mobile terminal 2 in contact with the mobile terminal 2, a connection start date and time that is a date and time when the connection that is the continuous contact is started, and a connection end date and time that is a date and time when the connection is ended are associated with each other. The connection information may be generated by the acquisition unit 11, on the basis of the contact information, or may be generated by the mobile terminal 2, on the basis of the contact information, and may be transmitted to the store determination device 1. For the generation of the connection information, for example, in a case where there is continuous contact for 5 minutes every minute in the contact information, the continuous contact is considered as 5-minute connection, and the start and the end of the corresponding contact date and time may be generated as the connection start date and time and the connection end date and time in the connection information, respectively.

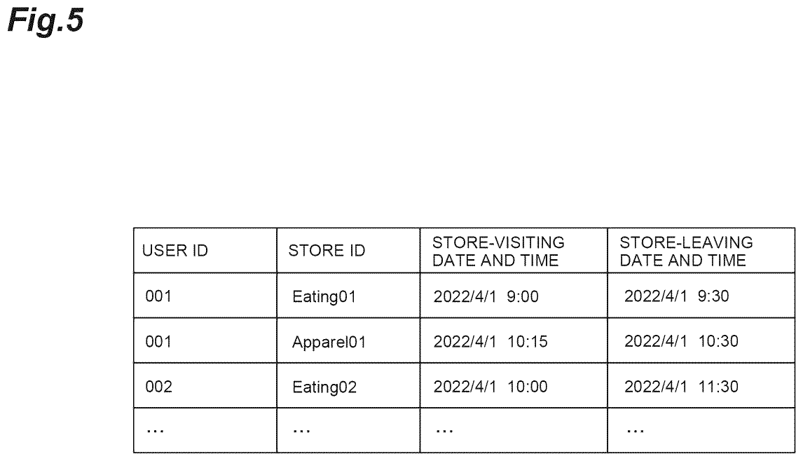

The storage unit 10 may store ground truth information relevant to the visit store of the user. FIG. 5 is a diagram illustrating a table example of the ground truth information. In the ground truth information illustrated in FIG. 5, a user ID, a store ID for identifying a store that a user identified by the user ID visits, a store-visiting date and time that is a date and time when the user visits the store, and a store-leaving date and time that is a date and time when the user leaves the store are associated with each other. The ground truth information is information (in which a visit with respect to a store is determined) generated by a method of the related art using an electrical wave positioning result, (the history of) position information by a GPS or the like, payment (history) information by a credit card, various types of electronic money, or the like, information of contact via near-field wireless communication, or the like. In this embodiment, the user of the ground truth information, that is, a user whose visit with respect to a store is determined by the method of the related art (with a high accuracy) will be referred to as a ground-truth user. Note that the target user may be a user other than the ground-truth user. As the target user set as a visit store determination target by the store determination device 1, a user for whom the position information, the payment information, and the like as described above are not capable of being acquired, and (only) the contact determination by BLE can be performed, rather than the ground-truth user, is assumed.

The acquisition unit 11 acquires information from another device via the network, and stores the acquired information by the storage unit 10. The acquisition unit 11 may process the acquired information while suitably referring to various types of information stored by the storage unit 10, and then, may store the information by the storage unit 10. For example, the acquisition unit 11 may acquire the contact information from each of the mobile terminals 2, may generate the connection information, on the basis of the acquired contact information, and may store the generated connection information by the storage unit 10. In addition, the acquisition unit 11 may acquire the contact information, the connection information, the ground truth information, the user adjacency information (described below) or the store adjacency information (described below), and the like, and may store the information by the storage unit 10.

The computation unit 12 computes the degree of similarity between user adjacency information relevant to adjacency between each user and other users and store adjacency information relevant to adjacency between each store and other users assumed as a user who is visiting the store. Adjacency between the users may be adjacency between the mobile terminals 2 carried by each user. The computation unit 12 may store a computation result of the degree of similarity by the storage unit 10, or may output the computation result to the determination unit 13 and the output unit 14.

The computation unit 12 may generate the user adjacency information, on the basis of at least one of the contact information, the connection information, the ground truth information, the past user adjacency information, and visit determination information (described below) or visit date and time information (described below), which are stored by the storage unit 10, and may compute the degree of similarity, on the basis of the generated user adjacency information. The user adjacency information may include at least one type of information relevant to the number of adjacent other users, the number of times of being adjacent to the other users, a time when being adjacent to the other users, and a store that the adjacent other users are visiting or are likely to visit.

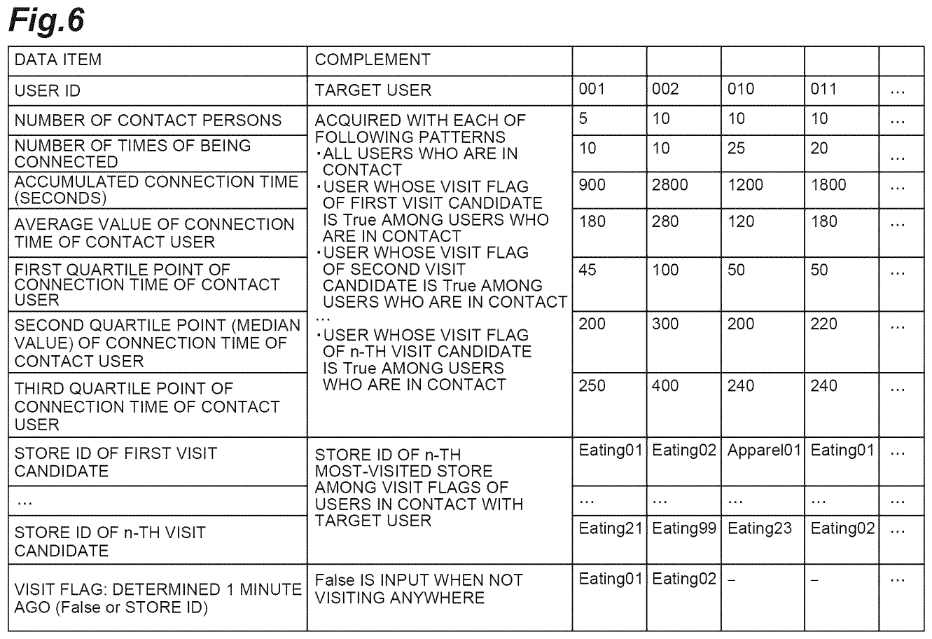

FIG. 6 is a diagram illustrating a table example of the user adjacency information. The user adjacency information illustrated in FIG. 6 is information (a statistic value) of a period (a target period) of the last N minutes (N is an integer of 1 or more, which is arbitrarily set by the administrator or the like of the store determination device 1, and for example, N=5), and is assumed to be computed by the computation unit 12 or the like every minute, but is not limited thereto. In the user adjacency information illustrated in FIG. 6, a user ID, the number of contact persons that is the number of other users in contact with (adjacent to) a user identified by the user ID during the target period, the number of times of being connected that is the number of times that the user is connected (adjacent) to the other users during the target period, an accumulated connection time (seconds) that is an accumulated time when the user is connected (adjacent) to the other users during the target period, an average value of a connection time of a contact user that is the average of a time of being connected to the other users in contact with (adjacent to) the user during the target period, the first quartile point of the connection time of the contact user that is the first quartile point of the connection time, the second quartile point (the median value) of the connection time of the contact user that is the second quartile point of the connection time, the third quartile point of the connection time of the contact user that is the third quartile point of the connection time, a store ID of a first visit candidate that is a store ID (a visit flag (described below) of the user who is in contact) of the most-visited store, a store ID of a second visit candidate that is a store ID of the second most-visited store, . . . , and a store ID of an n-th visit candidate that is a store ID of the n-th (n is an integer of 1 or more) most-visited store, among stores that (one or more) users in contact with the user during the target period are visiting or are likely to visit, and a visit flag (for example, determined 1 minute ago, and “False” in a case where there is no store) that is a store ID of a store that the user is visiting or is likely to visit during the target period are associated with each other. Items (the user ID, the number of contact persons, . . . , and the like) associated with each other will be referred to as data items. Among the data items, the number of contact persons, the number of times of being connected, the accumulated connection time, the average value of the connection time of the contact user, and the first quartile point, the second quartile point, and the third quartile point of the connection time of the contact user are computed by the computation unit 12, on the basis of the contact information or the connection information. Among the data items, the store ID of the first visit candidate, the store ID of the second visit candidate, . . . , and the store ID of the n-th visit candidate are computed by the computation unit 12, on the basis of the contact information or the connection information, the ground truth information, (a visit flag of) the past user adjacency information, and the visit determination information (described below) or the visit date and time information (described below). Among the data items, the visit flag is registered or updated by the determination unit 13 described below.

Note that the visit flag may not be associated with the user adjacency information. In this embodiment, a user who is visiting or is likely to visit a certain store will be suitably referred to as a user with a visit flag of the store since the visit flag of the user indicates the store. In the user adjacency information, the number of contact persons, the number of times of being connected, the accumulated connection time, the average value of the connection time of the contact user, the first quartile point of the connection time of the contact user, the second quartile point of the connection time of the contact user, and the third quartile point of the connection time of the contact user may be associated with each pattern of all the users who are in contact, a user whose visit flag of the first visit candidate is True (other than False) among the users who are in contact, a user whose visit flag of the second visit candidate is True among users who are in contact, . . . , and a user whose visit flag of the n-th visit candidate is True among the users who are in contact.

The computation unit 12 may generate the store adjacency information, on the basis of at least one of the contact information, the connection information, the ground truth information, the past user adjacency information, and the visit determination information (described below) or the visit date and time information (described below), which are stored by the storage unit 10, and may compute the degree of similarity, on the basis of the generated store adjacency information. The store adjacency information may include at least one type of information relevant to the number of adjacent other users assumed as the user who is visiting the store, the number of times of being adjacent to the other users, the time when being adjacent to the other users, and the store that the adjacent other users are visiting or are likely to visit.

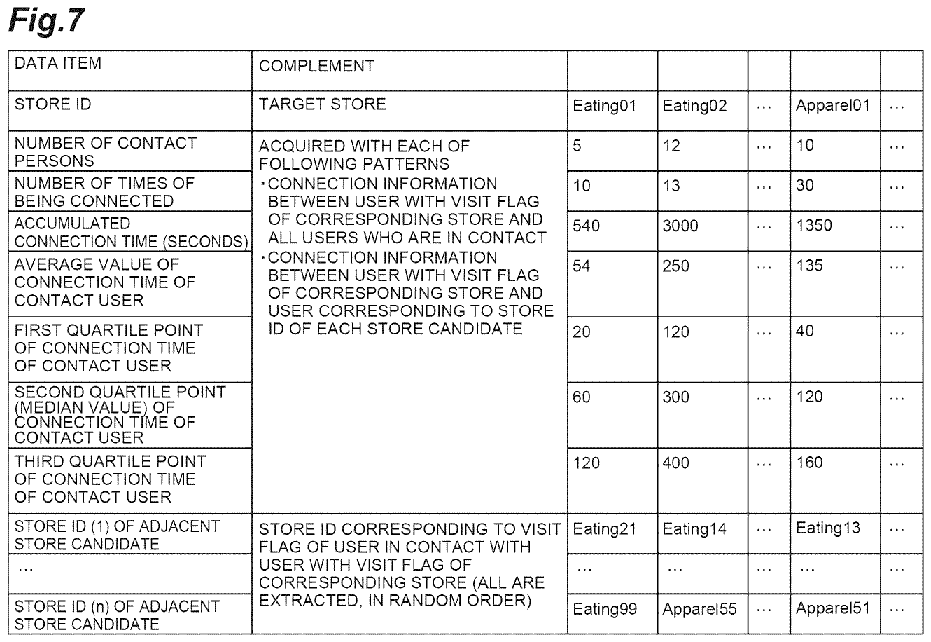

FIG. 7 is a diagram illustrating a table example of the store adjacency information. As with the user adjacency information, the store adjacency information illustrated in FIG. 7 is information (a statistic value) of a period (a target period) of the last N minutes (N is an integer of 1 or more, which is arbitrarily set by the administrator or the like of the store determination device 1, and for example, N=5), and is assumed to be computed by the computation unit 12 or the like every minute, but is not limited thereto. In the store adjacency information illustrated in FIG. 7, a store ID, the number of contact persons that is the number of other users in contact with (adjacent to) a user (an assumed user, the user with the visit flag of the store) who is visiting a store identified by the store ID during the target period, the number of times of being connected that is the number of times that the assumed user is connected (adjacent) to the other users during the target period, an accumulated connection time (seconds) that is an accumulated time when the assumed user is connected (adjacent) to the other users during the target period, an average value of the connection time of the contact user that is the average of a time of being connected to the other users in contact with (adjacent to) the assumed user during the target period, the first quartile point of the connection time of the contact user that is the first quartile point of the connection time, the second quartile point (the median value) of the connection time of the contact user that is the second quartile point of the connection time, the third quartile point of the connection time of the contact user that is the third quartile point of the connection time, and a store ID of an adjacent store candidate (a visit flag of the user who is in contact, all are extracted (1 to n), in random order) that is a store ID for identifying a store that (one or more) users in contact with the assumed user during the target period are visiting or are likely to visit are associated with each other. Items (the store ID, the number of contact persons, . . . , and the like) associated with each other will be referred to as data items.

Among the data items, the number of contact persons, the number of times of being connected, the accumulated connection time, the average value of the connection time of the contact user, the first quartile point, the second quartile point, and the third quartile point of the connection time of the contact user, and the store ID (1 to n) of the adjacent store candidate are computed by the computation unit 12, on the basis of the contact information or the connection information, the ground truth information, (the visit flag) of the past user adjacency information, and the visit determination information (described below) or the visit date and time information (described below).

Note that the store adjacency information is plausible information that is computed by the computation unit 12 using the contact information or the connection information of the user with the visit flag as each store ID and is obtained when visiting each store. There are various computation methods, but in this embodiment, simple averaging is used. In the store adjacency information, the number of contact persons, the number of times of being connected, the accumulated connection time, the average value of the connection time of the contact user, the first quartile point of the connection time of the contact user, the second quartile point of the connection time of the contact user, and the third quartile point of the connection time of the contact user may be associated with each pattern of connection information between the user with the visit flag of the store and all the users who are in contact, or connection information between the user with the visit flag of the store and the user corresponding to the store ID of each adjacent store candidate.

As described above, each of the user adjacency information and the store adjacency information may include at least one type of information relevant to the number of adjacent other users, the number of times of being adjacent to the other users, the time when being adjacent to the other users, and the store that the adjacent other users are visiting or are likely to visit. Each of the user adjacency information and the store adjacency information may include the same type of data items between both types of information (in order to compute the degree of similarity by the computation unit 12). When computing the degree of similarity, arithmetic is performed between the same type of data items between both types of information.

The computation unit 12 computes the degree of similarity between each user and each store to be a candidate, on the basis of an idea that users who are visiting the same store have similar contact information or connection information. There are various methods for computing the degree of similarity by the computation unit 12. In this embodiment, the description will be made by using cosine similarity, but is not limited thereto.

The store adjacency information is represented by the following formula, assuming each data item included as a vector. Note that st_id indicates the store ID.

$${St}^{st \_ id} = ( {St}_{1}^{st \_ id} , {St}_{2}^{st \_ id} , {St}_{3}^{st \_ id} , … {St}_{n}^{st \_ id} ) \qquad [ Mathematical Formula 1 ]$$

Similarly, the user adjacency information is represented by the following formula, assuming each data item included as a vector.

$${Us}^{st \_ id} = ( {Us}_{1}^{st \_ id} , {Us}_{2}^{st \_ id} , {Us}_{3}^{st \_ id} , … {Us}_{n}^{st \_ id} ) \qquad [ Mathematical Formula 2 ]$$

The degree of similarity (the cosine similarity) between the user adjacency information (of one user) and the store adjacency information (of one store), which is computed by the computation unit 12, is computed by the following mathematical formula.

$$\frac{{\sum }_{i = 1}^{n} {St}_{i}^{st \_ id} {Us}_{i}^{st \_ id}}{\sqrt{{( {\sum }_{i = 1}^{n} {St}_{i}^{st \_ id} )}^{2}} \sqrt{{( {\sum }_{i = 1}^{n} {Us}_{i}^{st \_ id} )}^{2}}} \qquad [ Mathematical Formula 3 ]$$

Note that for the ground-truth user, the degree of similarity may unconditionally be set as 1 (for stores other than those subjected to visit determination, the degree of similarity is computed as usual).

The method for computing the degree of similarity between a store ID of an X-th visit candidate in the user adjacency information and the store ID of the adjacent store candidate in the store adjacency information will be described in detail. When computing the degree of similarity, information linked to the store IDs of the first to n-th visit candidates of the user is used. For example, it is assumed that the store ID of the adjacent store candidate is “001”, “002”, “003”, “004”, and “005”, the store ID of the X-th visit candidate in the user adjacency information includes information up to the third candidate, and the store ID is sequentially “001”, “003”, and “004”. In this case, the degree of similarity is computed by using information of “001”, “003”, and “004”. That is, “002” and “005” are not used. In a case where an ID “006”, which is not in the store ID of the adjacent store candidate, is a candidate for the user, computation is performed by excluding “006”, or computation is performed by assuming that the content of data of the store ID “006” of the adjacent store candidate as “0”.

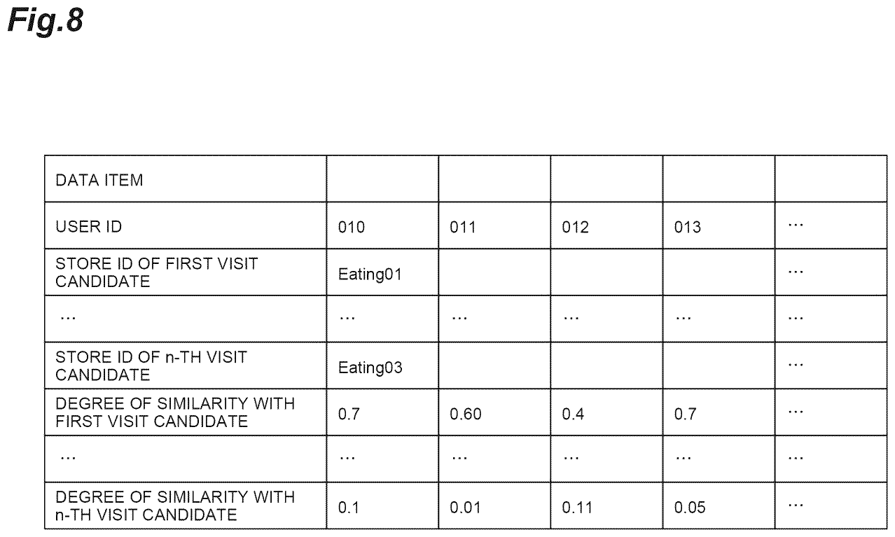

The computation unit 12 may generate degree of similarity information, on the basis of the computed degree of similarity. FIG. 8 is a diagram illustrating a table example of the degree of similarity information. In the degree of similarity information illustrated in FIG. 8, a user ID, a store ID of a first visit candidate of a user identified by the user ID, a store ID of a second visit candidate of the user, . . . , and a store ID of an n-th visit candidate of the user, and the degree of similarity with the first visit candidate that is the degree of similarity between user adjacency information of the user and store adjacency information of a store identified by the store ID of the first visit candidate, the degree of similarity with the second visit candidate that is the degree of similarity between the user adjacency information of the user and store adjacency information of a store identified by the store ID of the second visit candidate, . . . , and the degree of similarity with the n-th visit candidate that is the degree of similarity between the user adjacency information of the user and store adjacency information of a store identified by the store ID of the n-th visit candidate are associated with each other. The computation unit 12 may store the generated degree of similarity information by the storage unit 10, or may output the information to the determination unit 13 and the output unit 14.

The determination unit 13 determines the store that the user is visiting, on the basis of the degree of similarity computed by the computation unit 12. More specifically, the determination unit 13 determines the store that the user is visiting, on the basis of a computation result of the degree of similarity or the degree of similarity information, which is stored by the storage unit 10, or the computation result of the degree of similarity or the degree of similarity information, which is input from the computation unit 12. The determination unit 13 may store a store determination result by the storage unit 10, or may output the result to the output unit 14. The determination result, for example, may be a store ID of a store determined to be visited by each user, or may be a store ID of a store determined to be visited by each of one or more users designated in advance. There may be a plurality of stores determined for each user. For example, there may be a store ID of a first candidate store, a store ID of a second candidate store, and a store ID of a third candidate store (the top three stores with a high degree of similarity, the top three stores with a high degree of reliability described below, the top three stores with a weighted degree of reliability described below, and the like).

The determination unit 13, on the basis of the degree of similarity for each store between user adjacency information of one user and store adjacency information of each store, may determine a store that the one user is visiting. For example, in the degree of similarity information illustrated in FIG. 8, the determination unit 13, among the degree of similarity “0.7” with the first visit candidate to the degree of similarity “0.1” of the n-th visit candidate of the user ID “010”, determines a visit candidate store with the highest value (for example, a store that is the first visit candidate of “0.7” and includes a store ID of “Eating01”), as the store that the user identified by the user ID is visiting.

The determination unit 13 may correct the computed degree of similarity between user adjacency information of one user and store adjacency information of one store, on the basis of the degree of similarity between user adjacency information of a user adjacent to the one user and the store adjacency information of the one store, and may perform determination on the basis of the corrected degree of similarity (degree of reliability). The determination unit 13 may correct the computed degree of similarity between user adjacency information of one user and store adjacency information of one store to a value (for example, the average) based on the degree of similarity between user adjacency information of each user adjacent to the one user and the store adjacency information of the one store, and may perform determination on the basis of the corrected degree of similarity (degree of reliability).

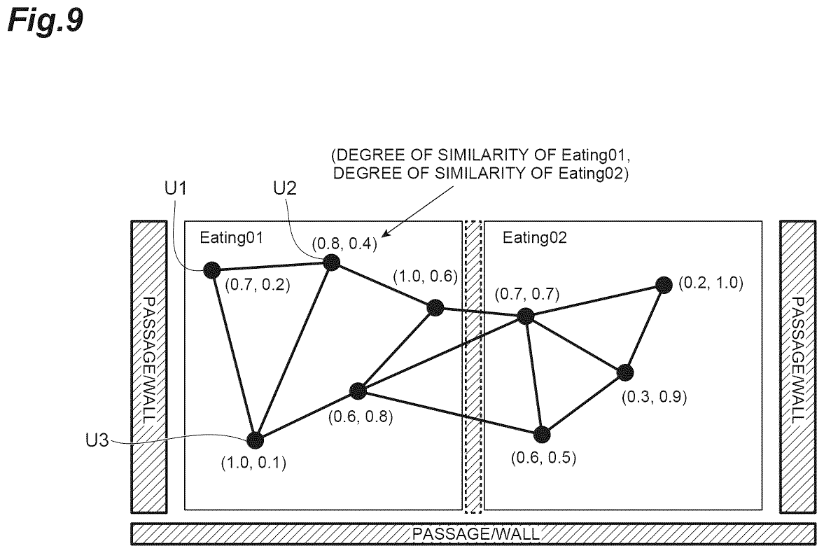

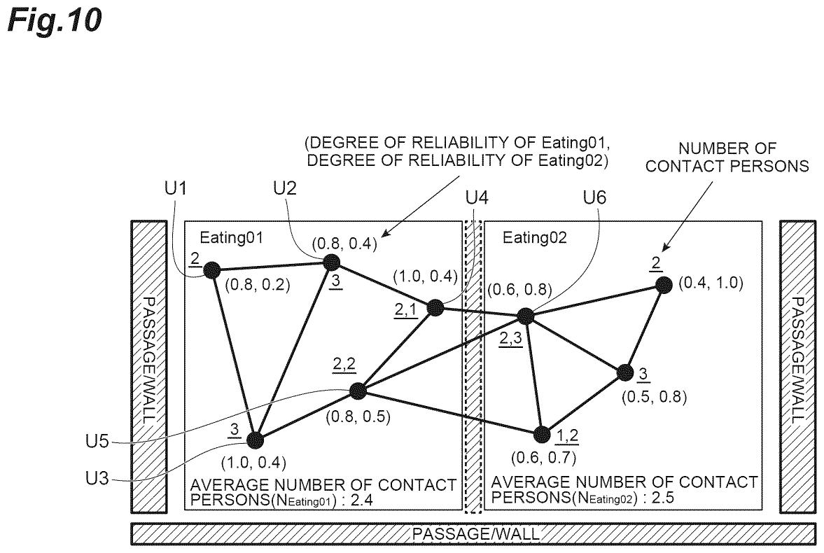

The description will be made with reference to FIG. 9 and FIG. 10.

FIG. 9 is a diagram illustrating an example of the degree of similarity for each user and for each store. In FIG. 9, there are two stores surrounded by passages or walls. Store IDs of two stores are “Eating01” and “Eating02”, respectively. A black circle in the store indicates a user. For example, a user U1, a user U2, and a user U3 are visiting the store with the store ID “Eating01”. A solid line between the users indicates that the users are adjacent to (in contact with, connected to) each other. In two numerical values delimited by a comma in parentheses indicated close to the user, the left numerical value indicates the degree of similarity between user adjacency information of the user and store adjacency information of the store with the store ID “Eating01”, and the right numerical value indicates the degree of similarity between user adjacency information of the user and the store adjacency information of the store with the store ID “Eating02”.

The determination unit 13, for example, corrects the degree of similarity “0.7” of the user U1 with respect to the store ID “Eating01” in FIG. 9 to the average of the degree of similarity “0.7”, the degree of similarity “0.8” of the user U2 adjacent to the user U1 with respect to the store ID “Eating01”, and the degree of similarity “1.0” of the user U3 adjacent to the user U1 with respect to the store ID “Eating01”, that is, “0.8” (=(0.7+0.8+1.0)/3, the hundredths place is rounded off). In this embodiment, the corrected degree of similarity will be referred to as the degree of reliability.

The computation of the average described above is indicated by the following formula.

$${Reliability}_{st \_ id}^{i} = \frac{1}{num\_of \_k} \sum {Similarity}_{st \_ id}^{k} \qquad [ Mathematical Formula 4 ]$$

Here, Reliability is the degree of reliability. Similarity is the degree of similarity. i is an index number of a user of interest. k is an index number of a user to be a target for average calculation (the user of interest, the contact user). num_of k is the number of users to be the target for the average calculation. That is, the computation unit 12 computes the degree of reliability by averaging the degree of similarity with the contact user for each store (visit flag).

FIG. 10 is a diagram illustrating an example of the degree of reliability for each user and for each store. FIG. 10 is a diagram in which the degree of similarity of FIG. 9 is replaced with the degree of reliability computed on the basis of the condition illustrated in FIG. 9. FIG. 10 is the same as FIG. 9 except that in two numerical values delimited by a comma in parentheses indicated close to the user in FIG. 10, the left numerical value indicates the degree of reliability of the user with respect to the store ID “Eating01”, and the right numerical value indicates the degree of reliability of the user with respect to the store ID “Eating02”. As described above, since “0.8” is computed by the determination unit 13 as the degree of reliability of the user U1, the left numerical value in parentheses indicated close to the user U1 in FIG. 10 is “0.8”. The other degree of reliability is also similarly computed and replaced. Note that the degree of reliability of the ground-truth user with respect to the store may be unconditionally “1” (here, for the other candidate stores, the degree of reliability is computed as usual).

The determination unit 13 may store a computation result of the computed degree of reliability by the storage unit 10. The determination unit 13, on the basis of the degree of reliability for each store between user adjacency information of one user and store adjacency information of each store, may determine a store that the one user is visiting. For example, as with the above description using FIG. 8, a visit candidate store with the largest value among the degrees of reliability of one user with respect to each store may be determined as the store that the one user is visiting.

The determination unit 13 may further correct the corrected degree of similarity (degree of reliability), on the basis of at least one of the number of users adjacent to one user in one store, and the number of users adjacent to a certain user who is visiting or is likely to visit one store in the one store, and may perform determination on the basis of the further corrected degree of similarity (the weighted degree of reliability). The determination unit 13 may further correct the corrected degree of similarity (degree of reliability), on the basis of a ratio between the number of users adjacent to one user in one store and a value based on the number of users adjacent to each user who is visiting or is likely to visit one store in the one store, and may perform determination on the basis of the further corrected degree of similarity (the weighted degree of reliability).

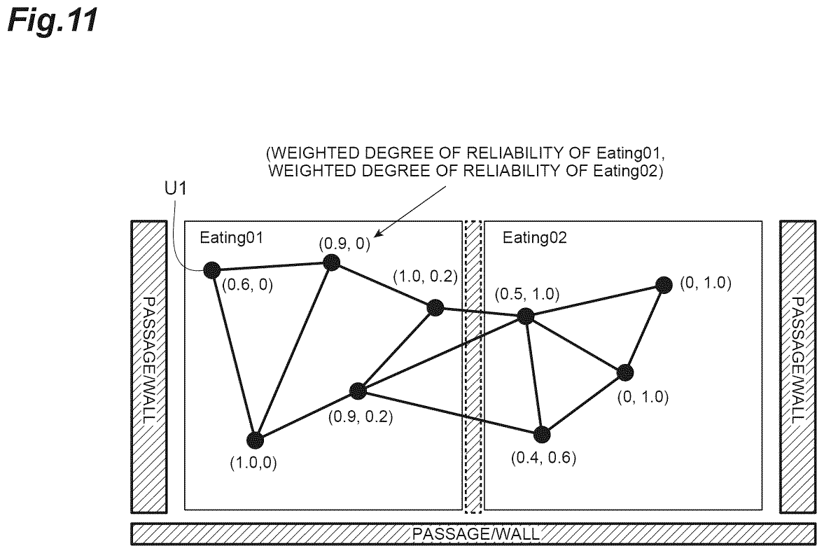

The description will be made in detail with reference to FIG. 10 and FIG. 11.

In FIG. 10, the number of contact persons that is the number of other users in contact with (adjacent to) the user is illustrated with an underline close to each user. For example, since the user U1 is in contact with two persons of the user U2 and the user U3 in the same store ID “Eating01”, the number of contact persons is “2”. In a case where the other users who are in contact spread over a plurality of stores, the number of contact persons is indicated by a comma-delimited numerical value. For example, the number of contact persons “2,1” of a user U4 indicates that the number of contact persons in the store ID “Eating01” is “2” (two persons of the user U2 and a user U5), and the number of contact persons in the store ID “Eating02” is “1” (one person of a user U6).

The determination unit 13, for example, corrects the degree of reliability “0.8” of the user U1 with respect to the store ID “Eating01” in FIG. 10 to “0.6” (=0.8*0.8, the hundredths place is rounded off) multiplied (weighted) with a ratio “0.8” (=2/2.4, the hundredths place is rounded off) between the number of contact persons “2” of the user U1 in the store ID “Eating01” and “2.4” (=(2+3+3+2+2)/5) that is the average of the number of contacts of each of the users U1 to U5, who are visiting or are likely to visit the store identified by the store ID “Eating01”, in the store. In this embodiment, the corrected degree of reliability will be referred to as the weighted degree of reliability.

A computation formula for the weighting described above will be described. The average number of contacts (connections) of each store is indicated by the following formula.

N_{st_id} [Mathematical Formula 5]

The number of contact (connected) persons of the user of interest in the store is indicated by the following formula.

$${n}_{st \_ id}^{i} \qquad [ Mathematical Formula 6 ]$$

In this case, the weight is indicated by the following formula.

$$\frac{{n}_{st \_ id}^{i}}{{N}_{st \_ id}} \qquad [ Mathematical Formula 7 ]$$

Then, weighting on the degree of reliability of each store is indicated by the following formula. Note that Reliability on the left member is the weighted degree of reliability, and Reliability on the right member is the degree of reliability (that is not weighted).

$${Reliability}_{st \_ id}^{i} = \frac{{n}_{st \_ id}^{i}}{{N}_{st \_ id}} {Reliability}_{st \_ id}^{i} \qquad [ Mathematical Formula 8 ]$$

FIG. 11 is a diagram illustrating an example of the weighted degree of reliability for each user and for each store. FIG. 11 is a diagram in which the degree of reliability of FIG. 10 is replaced with the weighted degree of reliability computed on the basis of the condition illustrated in FIG. 10. FIG. 11 is the same as FIG. 10 except that in two numerical values delimited by a comma in parentheses indicated close to the user in FIG. 11, the left numerical value indicates the weighted degree of reliability of the user with respect to the store ID “Eating01”, and the right numerical value indicates the weighted degree of reliability of the user with respect to the store ID “Eating02”. As described above, since “0.6” is computed by the determination unit 13 as the weighted degree of reliability of the user U1, the left numerical value in parentheses indicated close to the user U1 in FIG. 11 is “0.6”. The other degree of reliability is also similarly computed and replaced.

The determination unit 13 may store a computation result of the weighted degree of reliability, which is computed, by the storage unit 10. The determination unit 13, on the basis of the weighted degree of reliability for each store between user adjacency information of one user and store adjacency information of each store, may determine a store that the one user is visiting. For example, as with the above description using FIG. 8, a visit candidate store with the largest value among the weighted degrees of reliability of one user with respect to each store may be determined as the store that the one user is visiting.

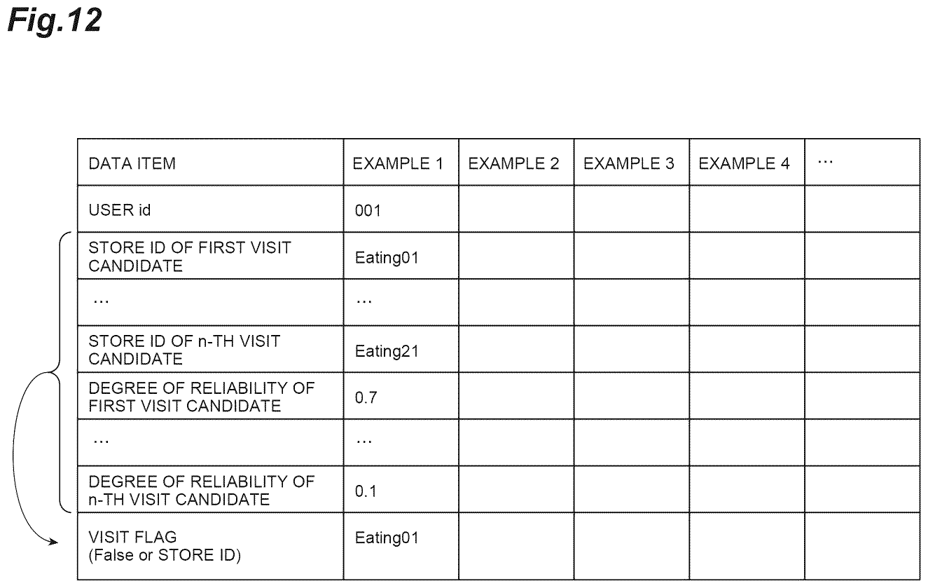

The determination unit 13 may generate visit flag information based on the degree of reliability or the weighted degree of reliability, which is computed. FIG. 12 is a diagram illustrating a table example of the visit flag information. In the visit flag information illustrated in FIG. 12, a user ID, a store ID of a first visit candidate of a user identified by the user ID, a store ID of a second visit candidate, . . . , and a store ID of an n-th visit candidate, the degree of reliability or the weighted degree of reliability of the user with respect to the first visit candidate, the degree of reliability or the weighted degree of reliability of the user with respect to the second visit candidate, . . . , and the degree of reliability or the weighted degree of reliability of the user with respect to the n-th visit candidate, and a visit flag are associated with each other. For example, the determination unit 13, among the degree of reliability or the weighted degree of reliability “0.7” with respect to the first visit candidate to the degree of reliability or the weighted degree of reliability “0.1” with respect to the n-th visit candidate of a user ID “001” in the visit flag information illustrated in FIG. 12, determines a visit candidate with the largest value or a visit candidate store with a predetermined threshold value (for example, “0.5”) or more, as a store that the user identified by the user ID is visiting. The determination unit 13 gives (registers, updates) the visit flag of the user adjacency information, on the basis of the determination result. The determination unit 13 may store the generated visit flag information by the storage unit 10.

The output unit 14 outputs the computation result of the degree of similarity, the degree of similarity information, or the store determination result, which is stored by the storage unit 10, the computation result of the degree of similarity or the degree of similarity information, which is input from the computation unit 12, or the store determination result, which is input from the determination unit 13, or performs output based on such results or information. The output, for example, may be displayed on a display that is one of output devices 1006 described below, or may be transmitted to another device via a communication device 1004 described below. For example, the output unit 14 may display one or more stores of each user indicated by the determination result input from the determination unit 13, as a store that each user is visiting.

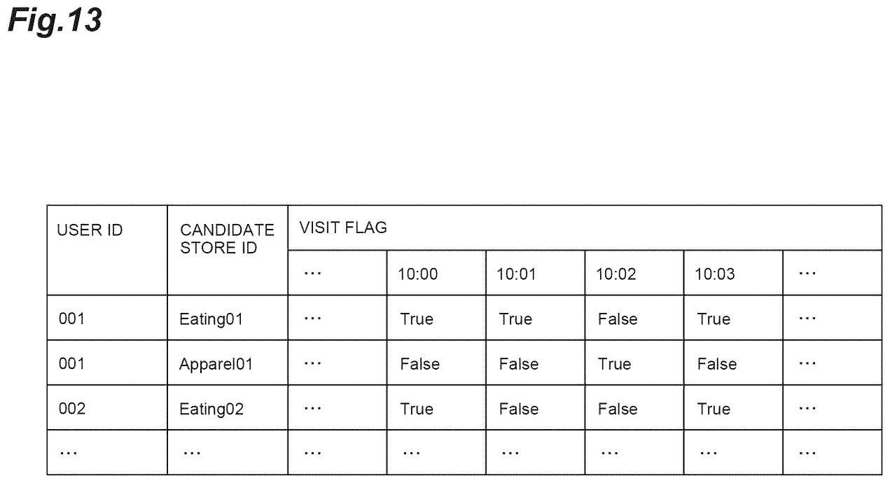

The output unit 14 may generate the visit determination information in which the visit determination of each user with respect to the store is organized, on the basis of the determination result of the determination unit 13. More specifically, the output unit 14 collects the determination result of the determination unit 13 at a predetermined time point (every minute) for a predetermined period, and organizes (compiles) the information to generate the visit determination information. FIG. 13 is a diagram illustrating a table example of the visit determination information. In the visit determination information illustrated in FIG. 13, a user ID, a candidate store ID that is a store ID of a visit candidate store of a user identified by the user ID, and a visit flag for each date and time (dates are omitted in FIG. 13) (“True” in a case where it is determined that the user is visiting the store, and “False” in a case where it is not determined that the user is visiting the store) are associated with each other. The output unit 14 may output the generated visit determination information.

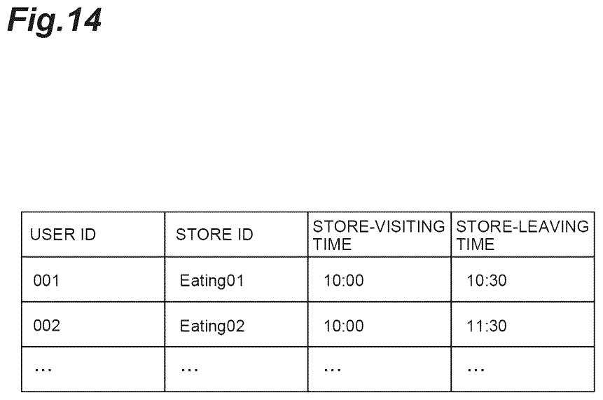

The output unit 14 may further organize the generated visit determination information to generate the visit date and time information in which a visit date and time of each user with respect to the store is organized. More specifically, the output unit 14 organizes (compiles) the information by determining that the user is visiting the store for X minutes in a case where there is visit determination for Y minutes or longer in continuous X minutes, in the visit determination information, and generates the visit date and time information. FIG. 14 is a diagram illustrating a table example of the visit date and time information. In the visit date and time information illustrated in FIG. 14, a user ID, a store ID of a store that a user identified by the user ID is likely to visit, a store-visiting time that is a time when the user is likely to visit the store (dates are omitted in FIG. 14), and a store-leaving time that is a time when the user is likely to leave the store (dates are omitted in FIG. 14) are associated with each other. The output unit 14 may output the generated visit date and time information.

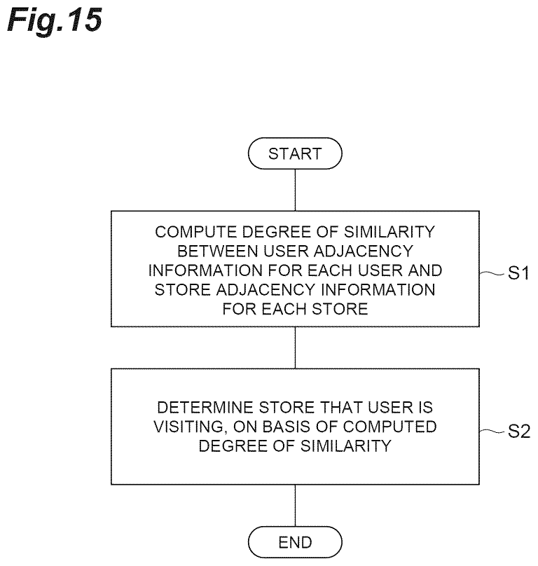

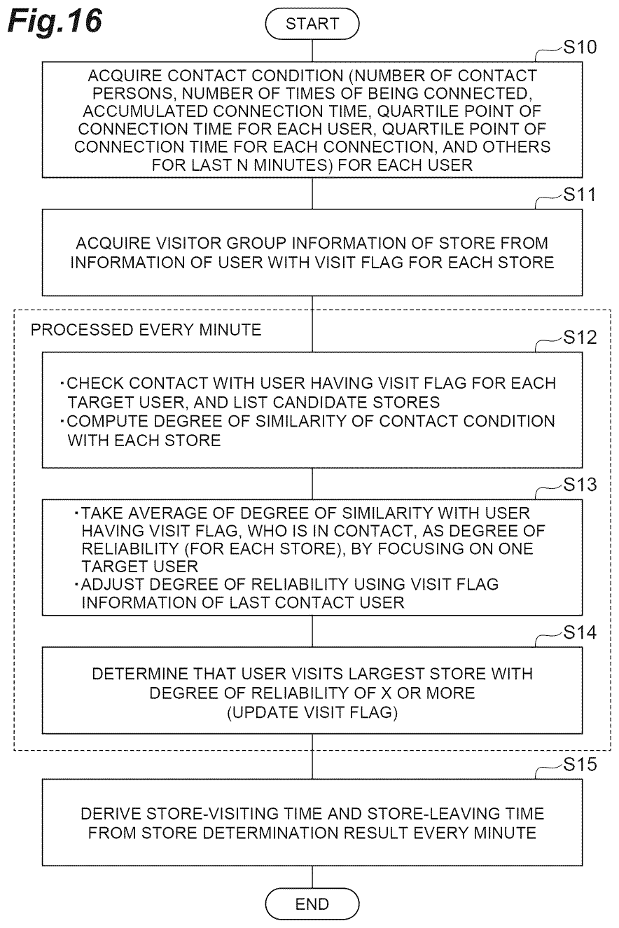

Subsequently, an example of processing (a store determination method) executed by the store determination device 1 will be described with reference to FIG. 15 and FIG. 16.

FIG. 15 is a flowchart illustrating an example of the processing executed by the store determination device 1. First, the computation unit 12 computes the degree of similarity between the user adjacency information relevant to the adjacency between the user and the other users and the store adjacency information relevant to the adjacency between each store and the other users assumed as the user who is visiting the store (step S1, a computing step). Next, the determination unit 13 determines the store that the user is visiting, on the basis of the degree of similarity computed in S1 (step S2, a determining step).

FIG. 16 is a flowchart illustrating another example of the processing executed by the store determination device 1. First, the computation unit 12 (or the acquisition unit 11) acquires a contact condition (the number of contact persons, the number of times of being connected, the accumulated connection time, the quartile point of the connection time for each user, the quartile point of the connection time for each connection, and the like for the last N minutes) for each user (step S10). Next, the computation unit 12 (or the acquisition unit 11) acquires (generates) the store adjacency information of the store from the information of the user with the visit flag for each store (step S11).

Next, the computation unit 12 checks contact with the user having the visit flag for each user, and lists the candidate stores (the store ID of the X-th visit candidate in the user adjacency information) to generate the user adjacency information and compute the degree of similarity of the contact condition with each store (step S12). Next, the computation unit 12, by focusing on one user, takes the average of the degree of similarity with the user having the visit flag, who is in contact, as the degree of reliability (for each store), and adjusts (corrects) the degree of reliability using the visit flag information of the last contact user (step S13). Next, the determination unit 13 determines that the user visits the largest store with the degree of reliability of X or more (updates the visit flag) (step S14). S12 to S14 are processed every minute (repeatedly). Next, the output unit 14 (or the determination unit 13) derives the store-visiting time and the store-leaving time from the store determination result every minute (step S15).

A modification example of the flowchart illustrated in FIG. 16 will be described. In S10, there may be processing of narrowing down the users (this is because it is assumed that calculation is performed for all the users at once, but in a case where there are an enormous number of users, a calculation amount increases, which is not practical). For example, a user who visits a store A and all users who are indirectly in contact the user on that day may be extracted. In addition, in S10, “restaurants”, “clothing stores”, or “not visiting anywhere” may be determined on the basis of the contact condition. Such a determination result may be used to determine whether to perform the subsequent processing, or may be used to adjust (correct) the degree of reliability. In S11, the store adjacency information may not be real-time data. For example, the store adjacency information may be data for the last 30 minutes, data for the same day and the same time, or the like. In S14, the degree of similarity of a connection condition with respect to all the users with the flag, who are in contact, may be acquired, and may be averaged for each store to determine that the user visits a store with the highest degree of similarity.

Subsequently, the function effect of the store determination device 1 according to the embodiment will be described.

According to the store determination device 1, the store determination device 1 includes the computation unit 12 computing the degree of similarity between the user adjacency information relevant to the adjacency between each user and the other users and the store adjacency information relevant to the adjacency between each store and the other users assumed as the user who is visiting the store, and the determination unit 13 determining the store that the user is visiting, on the basis of the degree of similarity computed by the computation unit 12. According to such a configuration, the degree of similarity between the user adjacency information for each user and the store adjacency information for each store is computed, and the store that the user is visiting is determined on the basis of the computed degree of similarity. That is, it is possible to determine the store that the user is visiting.

In addition, according to the store determination device 1, the adjacency between the users may be the adjacency between the mobile terminals 2 carried by each user. According to such a configuration, since the adjacency between the mobile terminals 2, that is, the adjacency between the users can be determined, for example, using near-field wireless communication by BLE or the like, it is possible to more reliably and easily ensure the user adjacency information and the store adjacency information relevant to the adjacency between the users.

In addition, according to the store determination device 1, each of the user adjacency information and the store adjacency information may include at least one type of information relevant to the number of adjacent other users, the number of times of being adjacent to the other users, the time when being adjacent to the other users, and the store that the adjacent other users are visiting or are likely to visit. According to such a configuration, it is possible to compute a more accurate degree of similarity, on the basis of more specific data relevant to the adjacency, and more accurately determine the store that the user is visiting.

In addition, according to the store determination device 1, the determination unit 13, on the basis of the degree of similarity for each store between the user adjacency information of the one user and the store adjacency information of each store, may determine the store that the one user is visiting. According to such a configuration, it is possible to determine the store that the one user is visiting.

In addition, according to the store determination device 1, the determination unit 13 may correct the computed degree of similarity between the user adjacency information of the one user and the store adjacency information of the one store, on the basis of the degree of similarity between the user adjacency information of the user adjacent to the one user and the store adjacency information of the one store, and may perform the determination on the basis of the corrected degree of similarity. According to such a configuration, since the degree of similarity is corrected on the basis of the user adjacent to the one user, it is possible to use a more accurate degree of similarity, and more accurately determine the store that the user is visiting.

In addition, according to the store determination device 1, the determination unit 13 may correct the computed degree of similarity between the user adjacency information of the one user and the store adjacency information of the one store to the value based on the degree of similarity, and the degree of similarity between the user adjacency information of each user adjacent to the one user and the store adjacency information of the one store, and may perform the determination on the basis of the corrected degree of similarity. According to such a configuration, since the degree of similarity is corrected on the basis of the user adjacent to the one user, it is possible to use a more accurate degree of similarity, and more accurately determine the store that the user is visiting.

In addition, according to the store determination device 1, the determination unit 13 may further correct the corrected degree of similarity, on the basis of at least one of the number of users adjacent to the one user in the one store and the number of users adjacent to the user who is visiting or is likely to visit the one store in the one store, and may perform the determination on the basis of the further corrected degree of similarity. According to such a configuration, since the degree of similarity is further corrected on the basis of at least one of the number of users adjacent to the one user in the one store and the number of users adjacent to the user who is visiting or is likely to visit the one store in the one store, it is possible to use a more accurate degree of similarity, and more accurately determine the store that the user is visiting.

In addition, according to the store determination device 1, the determination unit 13 may further correct the corrected degree of similarity, on the basis of the ratio between the number of users adjacent to the one user in the one store and the value based on the number of users adjacent to each user who is visiting or is likely to visit the one store in the one store, and may perform the determination on the basis of the further corrected degree of similarity. According to such a configuration, since the degree of similarity is further corrected on the basis of the ratio, it is possible to use a more accurate degree of similarity, and more accurately determine the store that the user is visiting.

According to the store determination device 1, it is possible to divide store-visiting determination between the adjacent stores.

In general, in order to measure the effect of measures and advertisements relevant to a commercial facility and analyze the users, it is preferable that which store is visited by a user unit can be accurately determined. As a method for determining a store visit, the use of the position information or the utilization of a payment history is considered, but it is difficult to acquire the position information or the information of the payment history of all the users. Contact information (BLE) between users by Bluetooth (Registered Trademark) can be more easily acquired, and the store determination device 1 is a visit determination method using the contact information.

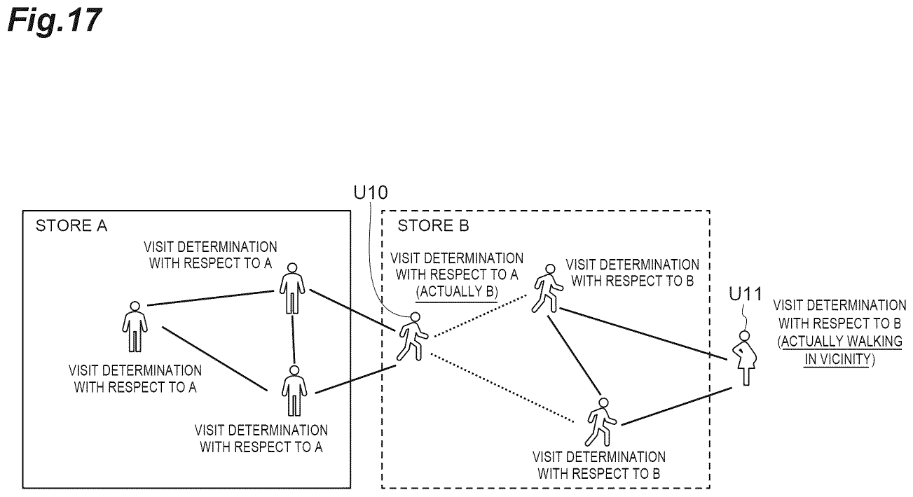

A problem of the related art will be described with reference to FIG. 17. FIG. 17 is a diagram illustrating a problem of store determination according to the related art. As the problem of the related art, it is general that a plurality of adjacent stores are placed in rows in the actual stores, and in a case where the division between the adjacent stores is not considered, the possibility of erroneous determination is high. For example, a user U10 in FIG. 17 is actually visiting a store B, but in the related art, it is erroneously determined that the user U10 is visiting a store A. In addition, there is a possibility that a person passing by the vicinity of the store is also erroneously determined as visiting the store due to temporary BLE detection. For example, a user U11 in FIG. 17 is just actually walking in the vicinity of the store B, but in the related art, it is erroneously determined that the user U11 is visiting the store B.

According to the store determination device 1, it is possible to accurately divide and determine a specific visit store from a plurality of adjacent stores on the basis of a BLE log, by targeting at a user whose visit is difficult to be determined by a method of the related art using electrical wave positioning, GPS, payment information, or the like. According to the store determination device 1, by comparing the BLE logs (the number of contact persons, the number of contact times, and the like) of a user group visiting a specific store, it is possible to estimate which store the user is highly likely to visit (introduce the concept of the degree of similarity). Further, according to the store determination device 1, by considering the visit flag information of the last contact user, it is possible to improve a determination accuracy (introduce the concept of the degree of reliability). According to the store determination device 1, it is possible to prevent the erroneous determination even in the case of the adjacent stores. In addition, according to the store determination device 1, it is possible to prevent the erroneous determination of a user passing by the vicinity of the specific store, such as a passerby.

The store determination device 1 compares the contact information of the individual user with the contact information of a group of the store A, the store B, . . . , to acquire the degree of similarity with each store. Then, the store determination device 1 improves the determination accuracy by considering the visit flag information of the last contact user.

A user for whom the BLE log can be acquired, but the other information such as the position information and the payment information is not capable of being acquired may be the target of the store determination device 1. Visit determination using information other than BLE (the position information and the payment information) may be regarded as the ground-truth user.

According to the store determination device 1, it is possible to consecutively determine a visit in chronological order.

Since there is a high possibility that a user in the vicinity of the boundary between a store and a store has a high degree of similarity in both of the stores, in the store determination device 1, the concept of the degree of reliability is introduced. Here, as the degree of reliability, the degree of similarity of a connected user with a visit flag is utilized. There are various methods for computing the degree of reliability, and in this embodiment, a specific example using the average has been described.

The store determination device 1 of the present disclosure may have the following configurations.
[1] A store determination device, including:
a computation unit computing a degree of similarity between user adjacency information relevant to adjacency between each user and other users and store adjacency information relevant to adjacency between each store and other users assumed as a user who is visiting the store; and
a determination unit determining the store that the user is visiting, on the basis of the degree of similarity computed by the computation unit.
[2] The store determination device according to [1],
in which adjacency between users is adjacency between mobile terminals carried by each user.
[3] The store determination device according to [1] or [2],
in which each of the user adjacency information and the store adjacency information includes at least one type of information relevant to the number of adjacent other users, the number of times of being adjacent to other users, a time when being adjacent to the other users, and a store that the adjacent other users are visiting or are likely to visit.
[4] The store determination device according to any one of [1] to [3],
in which the determination unit, on the basis of a degree of similarity for each store between user adjacency information of one user and store adjacency information of each store, determines a store that the one user is visiting.
[5] The store determination device according to any one of [1] to [4],
in which the determination unit corrects a computed degree of similarity between user adjacency information of one user and store adjacency information of one store, on the basis of a degree of similarity between user adjacency information of a user adjacent to the one user and the store adjacency information of the one store, and performs determination on the basis of the corrected degree of similarity.
[6] The store determination device according to any one of [1] to [5]
in which the determination unit corrects a computed degree of similarity between user adjacency information of one user and store adjacency information of one store to a value based on the degree of similarity, and a degree of similarity between user adjacency information of each user adjacent to the one user and the store adjacency information of the one store, and performs determination on the basis of the corrected degree of similarity.
[7] The store determination device according to [5] or [6],
in which the determination unit further corrects the corrected degree of similarity, on the basis of at least one of the number of users adjacent to the one user in the one store and the number of users adjacent to a user who is visiting or is likely to visit the one store in the one store, and performs determination on the basis of the further corrected degree of similarity.
[8] The store determination device according to any one of [5] to [7],
in which the determination unit further corrects the corrected degree of similarity, on the basis of a ratio between the number of users adjacent to the one user in the one store and a value based on the number of users adjacent to each user who is visiting or is likely to visit the one store in the one store, and performs determination on the basis of the further corrected degree of similarity.

Note that a block diagram used for the description of the above embodiment illustrates the blocks of function units. Such function blocks (configuration units) are attained by any combination of at least one of hardware and software. In addition, a method for attaining each of the function blocks is not particularly limited. That is, each of the function blocks may be attained by using one physically or logically coupled device, or may be attained by using a plurality of devices obtained by directly or indirectly (for example, in a wired or wireless manner) connecting two or more devices physically or logically separated from each other. The function block may be attained by combining software with the one device or the plurality of devices.

The function includes determining, judging, calculating, computing, processing, deriving, investigating, searching, ascertaining, receiving, transmitting, outputting, accessing, resolving, selecting, choosing, establishing, comparing, assuming, expecting, regarding, broadcasting, notifying, communicating, forwarding, configuring, reconfiguring, allocating (mapping), assigning, and the like, but is not limited thereto. For example, the function block (the configuration unit) performing the transmitting is referred to as a transmitting unit or a transmitter. In either case, as described above, a method for attaining the function block is not particularly limited.

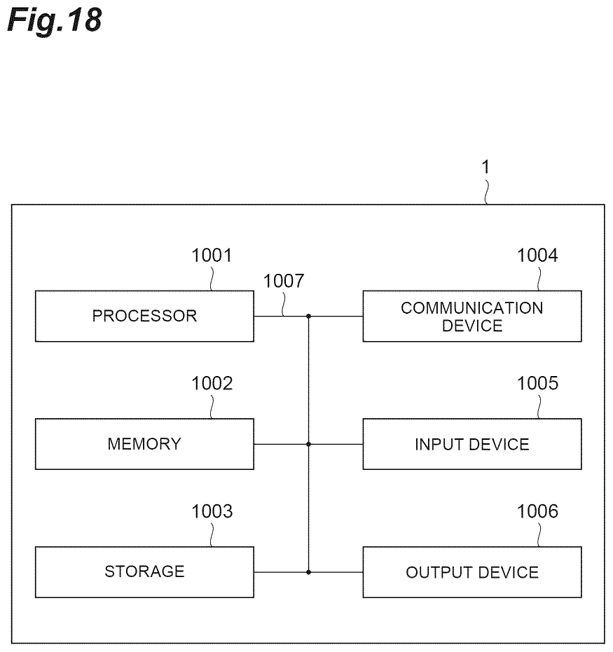

For example, the store determination device 1 or the like in one embodiment of the present disclosure may function as a computer performing the processing of the store determination method of the present disclosure. FIG. 18 is a diagram illustrating an example of a hardware configuration of the store determination device 1 according to one embodiment of the present disclosure. The store determination device 1 described above may be physically configured as a computer device including a processor 1001, a memory 1002, a storage 1003, a communication device 1004, an input device 1005, an output device 1006, a bus 1007, and the like.

Note that in the following description, the word “device” can be replaced with a circuit, a unit, or the like. The hardware configuration of the store determination device 1 may be configured to include one or a plurality of devices illustrated in the drawings, or may be configured to exclude some devices.

Each of the functions in the store determination device 1 is attained by reading predetermined software (program) on the hardware such as the processor 1001 and the memory 1002 such that the processor 1001 performs arithmetic, and controlling the communication of the communication device 1004 or controlling at least one of the reading and the writing of data in the memory 1002 and the storage 1003.

The processor 1001, for example, controls the entire computer by operating an operating system. The processor 1001 may be composed of a central processing unit (CPU) including an interface with a peripheral device, a control device, an arithmetic device, a register, and the like. For example, the acquisition unit 11, the computation unit 12, the determination unit 13, the output unit 14, and the like described above may be attained by the processor 1001.

In addition, the processor 1001 reads out a program (a program code), a software module, data, and the like from at least one of the storage 1003 and the communication device 1004 to the memory 1002, and executes various pieces of processing in accordance with the program and the like. As the program, a program for causing a computer to execute at least a part of the operation described in the above embodiment is used. For example, the acquisition unit 11, the computation unit 12, the determination unit 13, and the output unit 14 may be attained by a control program that is stored in the memory 1002 and operated in the processor 1001, and the other function blocks may be similarly attained. It has been described that the various pieces of processing described above are executed by one processor 1001, but the various pieces of processing may be simultaneously or sequentially executed by two or more processors 1001. The processor 1001 may be implemented by one or more chips. Note that the program may be transmitted from a network via an electric communication line.

The memory 1002 is a computer-readable recording medium, and for example, may be composed of at least one of a read only memory (ROM), an erasable programmable ROM (EPROM), an electrically erasable programmable ROM (EEPROM), a random access memory (RAM), and the like. The memory 1002 may be referred to as a register, a cache, a main memory (a main storage device), and the like.

The memory 1002 may store a program (a program code), a software module, and the like that can be executed to carry out a wireless communication method according to one embodiment of the present disclosure.

The storage 1003 is a computer-readable recording medium, and for example, may be composed of at least one of an optical disk such as a compact disc ROM (CD-ROM), a hard disk drive, a flexible disk, a magnetooptic disk (for example, a compact disk, a digital versatile disk, and a Blu-ray (Registered Trademark) disk), a smart card, a flash memory (for example, a card, a stick, and a key drive), a floppy (Registered Trademark) disk, a magnetic strip, and the like. The storage 1003 may be referred to as an auxiliary storage device. The storage medium described above, for example, may be a database, a server, and other suitable media including at least one of the memory 1002 and the storage 1003.

The communication device 1004 is hardware (a transmitting and receiving device) for performing communication with respect to a computer via at least one of a wired network and a wireless network, and for example, is also referred as a network device, a network controller, a network card, a communication module, and the like. The communication device 1004, for example, may be configured by including a high-frequency switch, a duplexer, a filter, a frequency synthesizer, and the like in order to attain at least one of frequency division duplex (FDD) and time division duplex (TDD). For example, the acquisition unit 11, the computation unit 12, the determination unit 13, the output unit 14, and the like described above may be attained by the communication device 1004.

The input device 1005 is an input device (for example, a keyboard, a mouse, a microphone, a switch, a button, a sensor, and the like) receiving input from the outside. The output device 1006 is an output device (for example, a display, a speaker, an LED lamp, and the like) carrying out output to the outside. Note that the input device 1005 and the output device 1006 may have an integrated configuration (for example, a touch panel).

In addition, each of the devices such as the processor 1001 and the memory 1002 is connected by the bus 1007 for performing the communication of the information. The bus 1007 may be configured by using a single bus, or may be configured by using different buses for each of the devices.

In addition, the store determination device 1 may be configured by including hardware such as a microprocessor, a digital signal processor (DSP), an application specific integrated circuit (ASIC), a programmable logic device (PLD), and a field programmable gate array (FPGA), and a part or all of each of the function blocks may be attained by the hardware. For example, the processor 1001 may be implemented by using at least one of the hardware.

The notifying of the information is not limited to the aspects/embodiments described in the present disclosure, and may be performed by using other methods.

Each of the aspects/embodiments described in the present disclosure may be applied to at least one of a system using long term evolution (LTE), LTE-advanced (LTE-A), SUPER 3G, IMT-advanced, a 4th generation (4G) mobile communication system, a 5th generation (5G) mobile communication system, future radio access (FRA), new radio (NR), W-CDMA (Registered Trademark), GSM (Registered Trademark), CDMA2000, an ultra mobile broadband (UMB), IEEE 802.11 (Wi-Fi (Registered Trademark)), IEEE 802.16 (WiMAX (Registered Trademark)), IEEE 802.20, an ultra-wideband (UWB), Bluetooth (Registered Trademark), and other suitable systems, and a next generation system extended based thereon. In addition, a plurality of systems may be applied in combination (for example, a combination between at least one of LTE and LTE-A and 5G, or the like).

The order of the processing procedure, the sequence, the flowchart, and the like of each of the aspects/embodiments described in the present disclosure may be changed unless there is contradiction. For example, in the method described in the present disclosure, the elements of various steps are presented by using an exemplary order, but the present disclosure is not limited to the presented specific order.

The input and output information or the like may be stored in a specific place (for example, a memory), or may be managed by using a management table. The input and output information or the like can be overwritten, updated, or edited. The output information or the like may be deleted. The input information or the like may be transmitted to other devices.

The determining may be performed by a value represented by 1 bit (0 or 1), may be performed by a truth value (Boolean: true or false), or may be performed by comparing numerical values (for example, comparing with a predetermined value).

Each of the aspects/embodiments described in the present disclosure may be used alone, may be used in combination, or may be used by being switched in accordance with the execution. In addition, the notifying of predetermined information (for example, the notifying of “X”) is not limited to being performed explicitly, but may be performed implicitly (for example, by not performing the notifying of the predetermined information).

The present disclosure has been described in detail, but it is obvious to a person skilled in the art that the present disclosure is not limited to the embodiment described in the present disclosure. The present disclosure can be carried out as modifications and variations without departing from the spirit and the scope of the present disclosure defined by the claims. Therefore, the description of the present disclosure is for illustrative purpose and is not intended to have any restrictive meaning on the present disclosure.

The software should be broadly construed to indicate an instruction, an instruction set, a code, a code segment, a program code, a program, a sub-program, a software module, an application, a software application, a software package, a routine, a sub-routine, an object, an executable file, an execution thread, a procedure, a function, and the like, regardless of being referred to as software, firmware, middleware, a microcode, and a hardware description language, or referred to as other names.

In addition, the software, the instruction, the information, and the like may be transmitted and received via a transmission medium. For example, in a case where the software is transmitted from a website, a server, or other remote sources by using at least one of a wired technology (a coaxial cable, an optical fiber cable, a twisted pair, a digital subscriber line (DSL), and the like) and a wireless technology (an infrared ray, a microwave, and the like), at least one of the wired technology and the wireless technology is included in the definition of the transmission medium.

The information, the signal, and the like described in the present disclosure may be represented by using any of various different technologies. For example, data, an instruction, a command, information, a signal, a bit, a symbol, a chip, and the like that can be mentioned over the entire description may be represented by a voltage, a current, an electromagnetic wave, a magnetic field or magnetic particles, an optical field or a photon, or any combination thereof.

Note that terms described in the present disclosure and terms required to understand the present disclosure may be replaced with terms having the same or similar meanings.

The terms “system” and “network” used in the present disclosure are used interchangeably.

In addition, the information, the parameter, and the like described in the present disclosure may be represented by using an absolute value, may be represented by using a relative value from a predetermined value, or may be represented by using another corresponding information.

The names used for the parameters described above are not a limited name in any respect. Further, a mathematical formula or the like using such parameters may be different from that explicitly disclosed in the present disclosure.

The term “determining” used in the present disclosure may include various operations. “Determining”, for example, may include considering judging, calculating, computing, processing, deriving, investigating, search (looking up or inquiry) (for example, search in a table, a database, or another data structure), and ascertaining as “determining”. In addition, “determining” may include considering receiving (for example, receiving information), transmitting (for example, transmitting information), input, output, and accessing (for example, accessing data in a memory) as “determining”. In addition, “determining” may include considering resolving, selecting, choosing, establishing, comparing, and the like as “determining”. That is, “determining” may include “determining” any operation. In addition, “determining” may be replaced with “assuming”, “expecting”, “considering”, and the like.

The terms “connected” and “coupled”, or any variations thereof indicate any direct or indirect connection or coupling between two or more elements, and may include one or more intermediate elements between two elements “connected” or “coupled” to each other. The elements may be coupled or connected to each other physically, logically, or in combination thereof. For example, “connecting” may be replaced with “accessing”. In a case where the terms are used in the present disclosure, it can be considered that two elements are “connected” or “coupled” to each other by using at least one of one or more electric wires, cables, and printed electric connections, and as several non-determinative and non-inclusive examples, by using electromagnetic energy or the like having a wavelength in a wireless frequency region, a microwave region, and a light (both of visible and non-visible) region.

The expression “on the basis of” used in the present disclosure does not indicate “only on the basis of” unless explicitly stated otherwise. In other words, the expression “on the basis of” indicates both of “only on the basis of” and “at least on the basis of”.

Any reference to the elements using the addresses “first”, “second”, and the like used in the present disclosure does not generally limit the amount or the order of the elements. Such addresses can be used in the present disclosure as a convenient method for distinguishing two or more elements. Therefore, the reference to the first and second elements does not indicate that only two elements can be adopted or the first element necessarily precedes the second element in any way.

The “means” in the configuration of each of the devices described above may be replaced with a “unit”, a “circuit”, a “device”, and the like.

In the present disclosure, in a case where “include”, “including”, and variations thereof are used, such terms are intended to be inclusive as with the term “comprising”. Further, the term “or” used in the present disclosure is intended not to be exclusive OR.

In the present disclosure, for example, in a case where articles are added by translation, such as a, an, and the in English, the present disclosure may include that the nouns following such articles are in a plural form.

In the present disclosure, the term “A and B are different” may indicate that “A and B are different from each other”. Note that, the term may indicate that “each of A and B is different from C”. The terms “separated”, “coupled”, and the like may be construed as with “different”.

### REFERENCE SIGNS LIST

1 . . . store determination device, 2 . . . mobile terminal, 3 . . . store determination system, 10 . . . storage unit, 11 . . . acquisition unit, 12 . . . computation unit, 13 . . . determination unit, 14 . . . output unit, 1001 . . . processor, 1002 . . . memory, 1003 . . . storage, 1004 . . . communication 10 device, 1005 . . . input device, 1006 . . . output device, 1007 . . . bus, U1, U2, U3, U4, U5, U6, U10, U11 . . . user.

1. A store determination device, comprising processing circuitry configured to:
compute a degree of similarity between user adjacency information relevant to adjacency between each user and other users and store adjacency information relevant to adjacency between each store and other users assumed as a user who is visiting the store; and
determine the store that the user is visiting, on the basis of the computed degree of similarity.

2. The store determination device according to claim 1,
wherein adjacency between users is adjacency between mobile terminals carried by each user.

3. The store determination device according to claim 1,
wherein each of the user adjacency information and the store adjacency information includes at least one type of information relevant to the number of adjacent other users, the number of times of being adjacent to other users, a time when being adjacent to the other users, and a store that the adjacent other users are visiting or are likely to visit.

4. The store determination device according to claim 1,
wherein the processing circuitry is configured to, on the basis of a degree of similarity for each store between user adjacency information of one user and store adjacency information of each store, determine a store that the one user is visiting.

5. The store determination device according to claim 1,
wherein the processing circuitry is configured to correct a computed degree of similarity between user adjacency information of one user and store adjacency information of one store, on the basis of a degree of similarity between user adjacency information of a user adjacent to the one user and the store adjacency information of the one store, and perform determination on the basis of the corrected degree of similarity.

6. The store determination device according to claim 1,
wherein the processing circuitry is configured to correct a computed degree of similarity between user adjacency information of one user and store adjacency information of one store to a value based on the degree of similarity, and a degree of similarity between user adjacency information of each user adjacent to the one user and the store adjacency information of the one store, and perform determination on the basis of the corrected degree of similarity.

7. The store determination device according to claim 5,
wherein the processing circuitry is further configured to correct the corrected degree of similarity, on the basis of at least one of the number of users adjacent to the one user in the one store and the number of users adjacent to a user who is visiting or is likely to visit the one store in the one store, and perform determination on the basis of the further corrected degree of similarity.

8. The store determination device according to claim 5,
wherein the processing circuitry is further configured to correct the corrected degree of similarity, on the basis of a ratio between the number of users adjacent to the one user in the one store and a value based on the number of users adjacent to each user who is visiting or is likely to visit the one store in the one store, and perform determination on the basis of the further corrected degree of similarity.

9. The store determination device according to claim 2,
wherein the processing circuitry is configured to, on the basis of a degree of similarity for each store between user adjacency information of one user and store adjacency information of each store, determine a store that the one user is visiting.

10. The store determination device according to claim 3,
wherein the processing circuitry is configured to, on the basis of a degree of similarity for each store between user adjacency information of one user and store adjacency information of each store, determine a store that the one user is visiting.

11. The store determination device according to claim 2,
wherein the processing circuitry is configured to correct a computed degree of similarity between user adjacency information of one user and store adjacency information of one store, on the basis of a degree of similarity between user adjacency information of a user adjacent to the one user and the store adjacency information of the one store, and perform determination on the basis of the corrected degree of similarity.

12. The store determination device according to claim 3,
wherein the processing circuitry is configured to correct a computed degree of similarity between user adjacency information of one user and store adjacency information of one store, on the basis of a degree of similarity between user adjacency information of a user adjacent to the one user and the store adjacency information of the one store, and perform determination on the basis of the corrected degree of similarity.

13. The store determination device according to claim 2,
wherein the processing circuitry is configured to correct a computed degree of similarity between user adjacency information of one user and store adjacency information of one store to a value based on the degree of similarity, and a degree of similarity between user adjacency information of each user adjacent to the one user and the store adjacency information of the one store, and perform determination on the basis of the corrected degree of similarity.

14. The store determination device according to claim 3,
wherein the processing circuitry is configured to correct a computed degree of similarity between user adjacency information of one user and store adjacency information of one store to a value based on the degree of similarity, and a degree of similarity between user adjacency information of each user adjacent to the one user and the store adjacency information of the one store, and perform determination on the basis of the corrected degree of similarity.
